(19) United States
(12) Patent Application Publication
(10) Pub. No.: US 2004/0103185 A1
(43) Pub. Date: May 27, 2004

(54) Adaptive self-repair and configuration in distributed systems

(76) Inventor: Nathan Hideaki Combs, Andover, MA (US)

Correspondence Address: VERIZON CORPORATE SERVICES GROUP INC., C/O CHRISTIAN R. ANDERSEN, 600 HIDDEN RIDGE DRIVE, MAILCODE HQEO3H14, IRVING, TX, 75038, US

(21) Appl. No.: 10/301,265

(22) Filed: Nov. 21, 2002

(51) Int. Cl. G06F 15/173

(52) U.S. Cl. 709/224; 709/225

(57) ABSTRACT

A distributed application [200] includes the ability to adaptively mirror components in the application, giving the application the ability to self-heal. Hint data [600] and constraint data [500] are used when mirroring a failing component and when initially assembling a distributed workflow. The constraint data [500] defines relatively rigid service rules and the hint data defines less-rigid “suggestive” service rules.

### GOVERNMENT INTEREST

The U.S. Government has a paid-up license in this invention as provided by the terms of contract No. F30602-00-C-0203 awarded by the Defense Advanced Research Projects Agency (DARPA).

### BACKGROUND OF THE INVENTION

A. Field of the Invention

The present invention relates generally to computer software design, and more particularly, to self-healing distributed computing systems.

B. Description of Related Art

“System of systems” architectures refer to a computing hardware/software system that is formed from a number of sub-systems. The sub-systems may be distributed geographically via a computer network. The promise of loosely-coupled system of systems designs provides the possibility of building large, sophisticated applications far more quickly and cheaply than can be achieved through traditional integrated components.

The Achilles heel of system of systems architectures is fixing and evolving them. A failure in one of the sub-systems can cause the whole system to fail. Conventionally, monitoring such complex system of systems architectures relied on one or more human administrators to fix problems as they occur. In some existing systems, the monitoring process is automated as much as possible. In these existing approaches, the human administrator or automated administrator tends to make repair decisions based on the complete architectural model of the system.

As a result, there is a need in the art for improved monitoring and repair techniques for distributed system of systems architectures.

### SUMMARY OF THE INVENTION

Systems and methods are disclosed herein for performing self-repair and monitoring in a distributed system of systems computing architecture. The systems and methods are located close to the workflow and are able to repair problems as they arise, potentially stopping problems before their effects spread.

One aspect of the invention is directed to a method for replacing a first service in a distributed application. The method includes monitoring the first service and determining, based on the monitoring, when the first service stops providing an acceptable level of service. The method further includes substituting a mirror service for the first service when the first service is determined to have stopped providing the acceptable level of service. The mirror service is determined based on directive information that includes hint information and constraint information. The constraint information defines rigid service rules and the hint information provides suggestive information relating to services.

A second aspect of the invention is directed to a method for assembling a workflow of distributed service providers. The method includes receiving a request for a first service, where the request includes constraint information and hint information. The constraint information defines rigid service rules and the hint information provides suggestive information relating to services. The method also includes requesting a second service required to complete the first service based on the constraint information and the hint information. The method further includes receiving feedback information from the second service and modifying the hint information based on the feedback information.

Another aspect of the invention is directed to a system including a first computing device and a second computing device. The first computing device includes a first processor and a first memory operatively coupled to the first processor. The first memory includes instructions for implementing a first service, where the first service includes constraint information and hint information. The constraint information defines rigid service rules and the hint information provides suggestive information relating to the first service. The hint information is based on feedback information. The second computing device includes a second processor and a second memory operatively coupled to the second processor. The second memory includes instructions for implementing a second service and instructions for receiving a request from the first service to invoke the second service. The request includes the constraint information and the hint information. The second memory additionally includes instructions for providing the feedback information to the first service based on execution of the first service.

### BRIEF DESCRIPTION OF THE DRAWINGS

The accompanying drawings, which are incorporated in and constitute a part of this specification, illustrate the invention and, together with the description, explain the invention. In the drawings,

FIG. 1 is a diagram of an exemplary system in which concepts consistent with the invention may be implemented;

FIG. 2 is a diagram illustrating logical components for an exemplary system of systems distributed application;

FIG. 3 is a diagram illustrating the concept of probes and gauges in a software environment consistent with aspects of the invention;

FIG. 4 is a diagram illustrating the contracting of a number of service providers to create a complete service workflow;

FIG. 5 is a diagram illustrating an exemplary constraint data structure;

FIG. 6 is a diagram illustrating an exemplary hint data structure;

FIG. 7 is a diagram illustrating a hint generation engine consistent with an aspect of the invention; and

FIG. 8 is a flow chart illustrating methods for performing dynamic service substitution consistent with an aspect of the invention.

### DETAILED DESCRIPTION

The following detailed description of the invention refers to the accompanying drawings. The same reference numbers in different drawings may identify the same or similar elements. Also, the following detailed description does not limit the invention. Instead, the scope of the invention is defined by the appended claims and equivalents.

As described herein, connectors in a distributed network implement adaptive mirroring for service providers in the network. When selecting a mirrored service or when initially assembling a workflow of service providers, “Hint” and “Constraint” configuration data is used to intelligently select service providers.

### Exemplary System

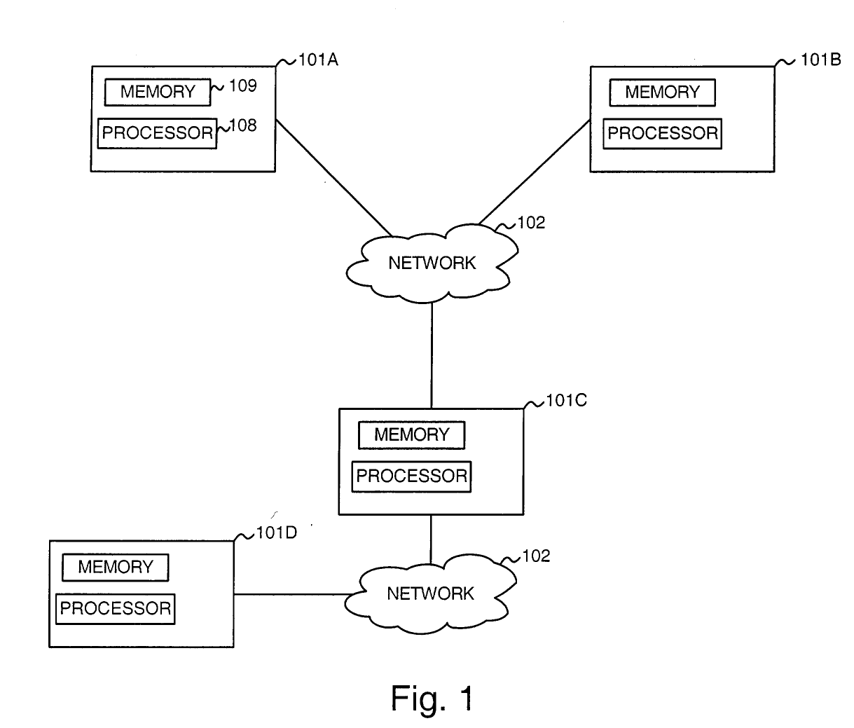

FIG. 1 is a diagram of an exemplary system in which concepts consistent with the invention may be implemented. The system includes computing devices 101A-101D connected to one or more networks 102. Networks 102 may include local area networks (LANs), wide area networks (WANs), or other types of networks. Computing devices 101A-101D each include a computer-readable medium 109, such as random access memory, coupled to a processor 108. Processor 108 executes program instructions stored in memory 109. Processor 108 can be any of a number of well known computer processors, such as processors from Intel Corporation, of Santa Clara, Calif. Computing devices 101 may also include a number of additional external or internal devices, such as, without limitation, a mouse, a CD-ROM, a keyboard, and a display.

In general, computing device 101 may be any type of computing platform connected to a network and that interacts with application programs, such as a digital assistant or a “smart” cellular telephone or pager. Computing device 101 is exemplary only; concepts consistent with the present invention can be implemented on any computing device.

Memory 109 may contain application programs. Application programs running on multiple ones of computing devices 101A-101D may act together to form a single distributed application. For example, computing device 101A may act as a client interface for an application that relies on data generated by computing devices 101B-101D. In this example, each of computing devices 101B-101D, when generating data, may request information from other computing devices (not shown). In this manner, computing devices 101B-101D can form a multi-level distributed system.

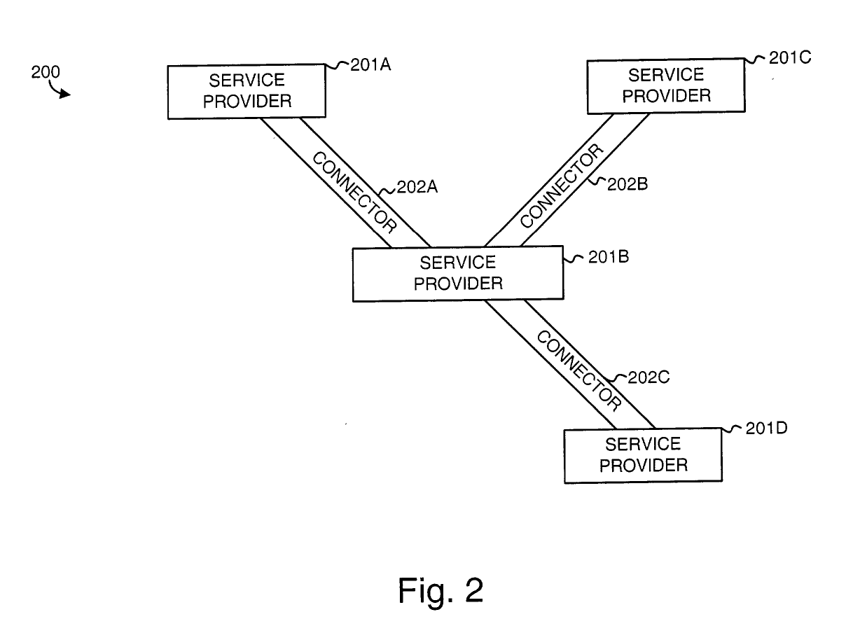

FIG. 2 is a diagram illustrating logical components for an exemplary system of systems distributed application 200. Distributed application 200 may include a number of service providers 201A-201D (collectively referred to as service providers 201). Service providers 201 form the constituent components of distributed application 200. Each of service providers 201A-201D may provide one or more services (e.g., database lookup services, specialized processing services, etc.) to other service providers or other entities. Service providers 201 may be physically implemented on multiple computing devices in a network. The physical nodes of the network are not shown in FIG. 2.

Connectors 202A-202C connect service providers 201. Connectors 202 may be implemented using any of a number of remote connectivity protocols, such as the Java Remote Method Invocation (RMI) protocol. Connectors 202 may be implemented as components within service providers 201 that communicate via RMI calls to a corresponding component in another of service providers 201. In general, RMI enables the creation of distributed applications in which the methods of remote objects can be invoked. A remote object can be called once the calling object obtains a reference to the remote object, either by looking up the remote object in a bootstrap-naming service provided by RMI, or by receiving the reference as an argument or a return value.

Although connectors 202 are shown as being logically separate from service providers 201, in some implementations, connectors 202 may be modeled as a service provider that provides connectivity functions. Thus, in this sense, distributed application 200 can be thought of as a number of service providers arranged in a distributed network architecture. The distributed architecture may be based on, for example, the Java Jini architecture.

Furthermore, while connectors 202 are shown to be complete and indivisible, they may in fact be composed of multiple service providers linked using other connectors. With this invention, such a connector (internally composed of many service providers and connectors) can be used to implement adaptive mirroring.

### Adaptive Mirroring

Consistent with an aspect of the invention, connectors 202 may use probes to strategically intercept service provider control flow. A probe may be, for example, a component within one of service providers 201 that monitors certain aspects of the service provider. For example, a probe may monitor communication latency of a service provider. Probes may be used in conjunction with gauges, where a gauge is a software component that aggregates and interprets probe data.

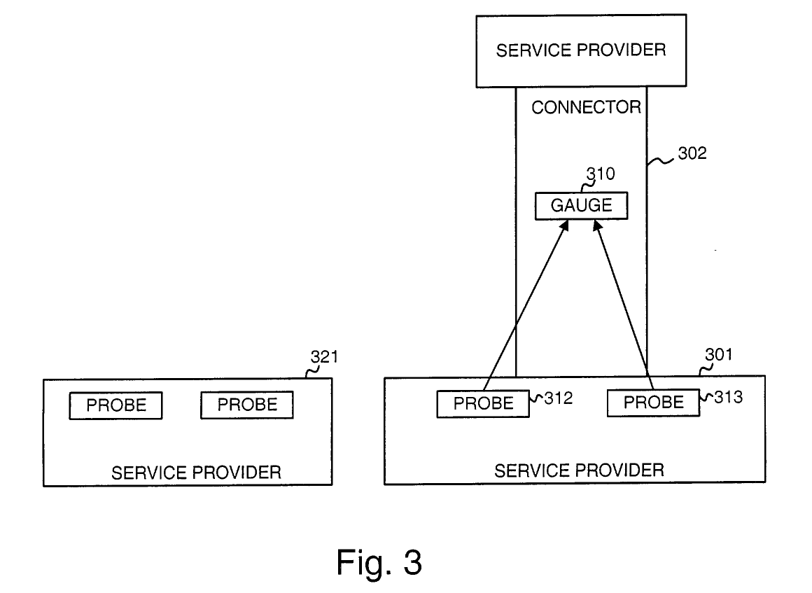

FIG. 3 is a diagram illustrating the concept of probes and gauges in a software environment consistent with aspects of the invention. As shown, a gauge 310, which may be associated with a connector 302, receives data from probes 312 and 313, which may be associated with a service provider 301. Gauge 310 may be designed to aggregate data from probes 312 and 313 and to output a gauge output value based on the two probe inputs. For example, probes 312 and 313 may each measure latency for different portions of service provider 301. Gauge 310 may sum the two received latency measurements to generate a representation of the total latency of service provider 301.

Service provider 321 may provide services that mirror the services provided by service provider 301. That is, the services provided by service provider 321 can be substituted as a redundant backup for the services provided by service provider 301.

Based on the output of one or more gauges 310, connector 302 may make a decision to replace service provider 301 with service provider 321. This replacement may be performed when gauge 310 indicates an outright failure or a constraint violation (e.g., bandwidth, load-balancing considerations etc.) of service provider 301. The pool of possible substitute services for service provider 301 may be predetermined in connector 302. For example, an operator may identify possible substitute services when configuring connector 302. In other implementations, connector 302 may dynamically add service providers to the list of substitute service providers based on a dynamic service discovery function in the network. By adaptively switching to a mirrored service, either during initial connection to the service or during run-time operation of the service, connector 302 implements self-healing within the systems of distributed application 200. It should be noted that connector 302, as depicted, represents a logical relationship between either 301 or 321. The actual (physical) connector may maintain references to both service providers or may use a service provider which can broker such references.

### Dynamic Service and Connector Substitution

Adaptive mirroring, as described above, repairs service providers in a system of systems architecture through the dynamic substitution of services. Concepts consistent with the present invention extend the adaptive mirroring concept described above to include the initial assembly of service providers into a workflow using directive information propagated with the workflow.

The actual process of assembling and replacing service providers with a substitute service provider may be based on a Service and Contract (S+C) workflow protocol that dynamically substitutes services in response to runtime performance metrics. Although a single service provider 301 is shown in FIG. 3 as providing a single service, in practice, a single “service” may be implemented by multiple service providers linked using other connectors. An incoming service request may stimulate a distributed chain of requests leading to the composition and invocation of a distributed workflow. The workflow may be assembled via a request-accept process in which services are requested and service providers can agree to accept the services. Before a service provider agrees to accept a request, it may request services from one or more additional service providers. In this manner, a service workflow is established. A workflow represents the service commitments of service providers to fulfill service requests.

Acceptance by a service provider in the S+C workflow protocol is initially tentative. When all service providers agree to accept, thereby creating a complete infrastructure for a high-level service, the service providers are “contracted” and invocation of the high-level service commences. The workflow assembly process flows in the forward direction (from the root request outwards). The invocation process flows in the reverse direction (leaves-to-root).

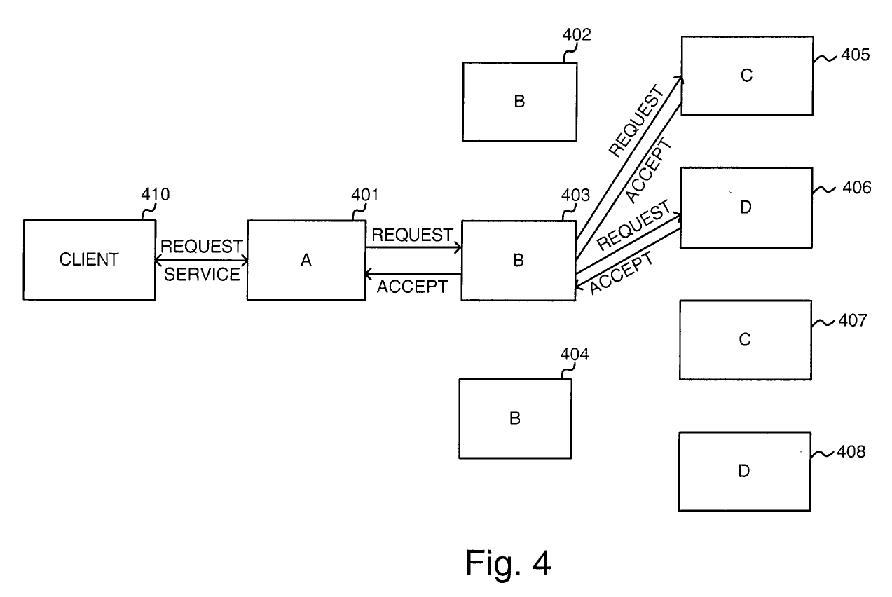

FIG. 4 is a diagram illustrating the contracting of a number of service providers to create a complete service workflow. For ease of explanation, connectors 202 are not shown in FIG. 4. Connectors might be a specialized type of service provider: for example, a service provider might connect to an external data source. A connector might also include two or more specialized service providers and link them via a service workflow. So for example, a connector might connect a data source to a data consumer (e.g. an application) using a service workflow. The service workflow may contain other service providers in between the data source and consumer.

In FIG. 4, four different services are offered by a number of different service providers 401-408. Service provider 401 offers a service “A”, service providers 402-404 offer a service “B”, service providers 405 and 407 offer a service “C”, and service providers 406 and 408 offer a service “D.” Service B may be a sub-service of service A, while services C and D may be sub-services of service B.

In response to a request for service A from client 410, service provider 401 may complete the portions of service A that it is able to and solicit one of service providers 402-404, such as service provider 403, for the remainder of service A (i.e., service B). Service provider 403 may require services C and D to complete service B. Accordingly, service provider 403 may then solicit services C and D from service providers 405 and 406. Services are solicited through a service request to the target service provider. When all of service providers 401, 403, 405, and 406 have accepted a request, these services providers are contracted and invocation begins. Service providers 405 and 406 may be invoked first, followed by service provider 403, and then service provider 401. In this manner, the results of services C and D are provided to service provider 403, so that the result of service B can then be provided to service provider 401. Thus, as previously mentioned, the workflow assembly process flows in the forward direction (e.g., assembly of service provider 401, 403, and 405/406) while invocation flows in the reverse direction (e.g., invocation of service providers 405/406, 403, and 401).

As previously mentioned, service provider 401 initially requests that service provider 403 agree to provide service B. If service provider 403 rejects the request or if service provider 403 fails during operation it may be replaced by a suitable substitute service provider, such as service provider 402 or 404. The choice of which substitute service provider to use as a replacement or which service provider to initially use may be based on directive information propagated though the workflow path. Service providers use the directive information when making decisions about which additional service providers to request services from. Directive information may be classified into two broad classes: Constraints and Hints.

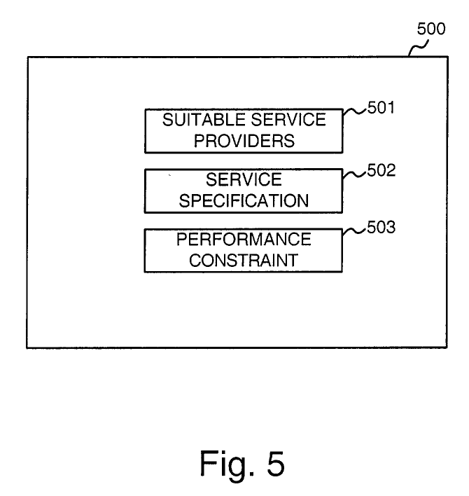

Constraints may be relatively rigid rules that dictate service criteria. FIG. 5 is a diagram illustrating an exemplary constraint data structure 500. Constraint data structure 500 may include a list of suitable service providers 501, a general service specification 502, and additional performance constraint information 503. The service specification 502 may describe the requirements of the service. For example, a service that prints a picture may specify that a suitable service provider must be able to print in color. In some distributed network infrastructures, such as a Java Jini based infrastructure, components entering the system can broadcast their capabilities to other components in the system. Service specification 502 allows service providers to dynamically discover new compatible services as the new services are brought on-line. Performance constraint information 503 may include, for example, maximum latency information tolerable by the service. If a service falls below a quality level dictated by performance constraint information 503, a mirror service may instead be invoked.

The entries in constraint data structure 500 are exemplary. One of ordinary skill in the art will recognize that additional or different entries could be used.

Hints, in contrast to constraints, are non-rigid rules used to shape the workflow during the service assembly process. For example, based on previous experience, hints may suggest (to the infrastructure) service destinations as well as reasonable invocation times associated with a particular service.

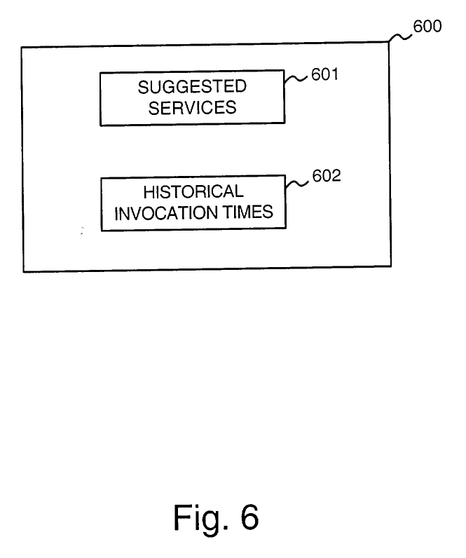

FIG. 6 is a diagram illustrating an exemplary hint data structure 600. As shown, data structure 600 includes suggested service destinations 601 and historical invocation time information 602 associated with services. Service providers may, for example, favor services that have better historical invocation times. Service providers may pass back feedback information to their requesting service which may then be incorporated into hint data structure 600. In this manner, modifications to hint data structure 600 may be used to prospectively improve the performance of the system.

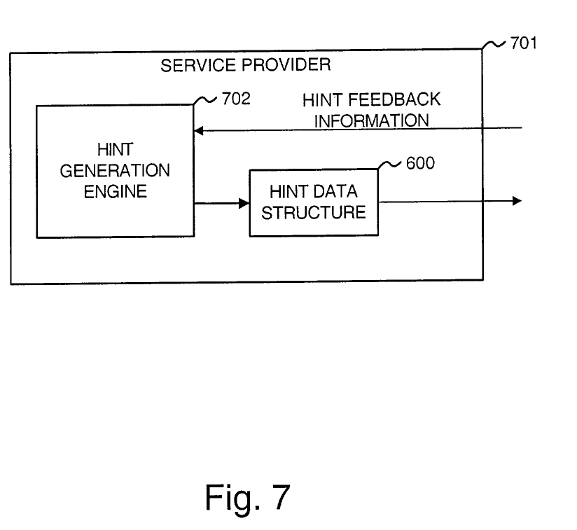

FIG. 7 is a diagram illustrating a hint generation engine 702 consistent with an aspect of the invention. Hint generation engine 702 may be implemented within a service provider 701. More typically, the service provider 701 will be the initial or root service provider in a larger workflow. It is also possible to separate the hint generation engine into another software component that can observe the service provider 701 and its actions within the software system. Based on the information received from downstream service providers (“service feedback information”), hint generation engine 702 may modify hint data structure 600. More particularly, hint generation engine 702 may analyze the service feedback information from a service workflow and modify hint data structure 600 when appropriate to improve the usefulness of hint data structure 600 to downstream service providers. The analysis by hint generation engine 702 may be based on, for example, a set of predefined rules.

### System Operation

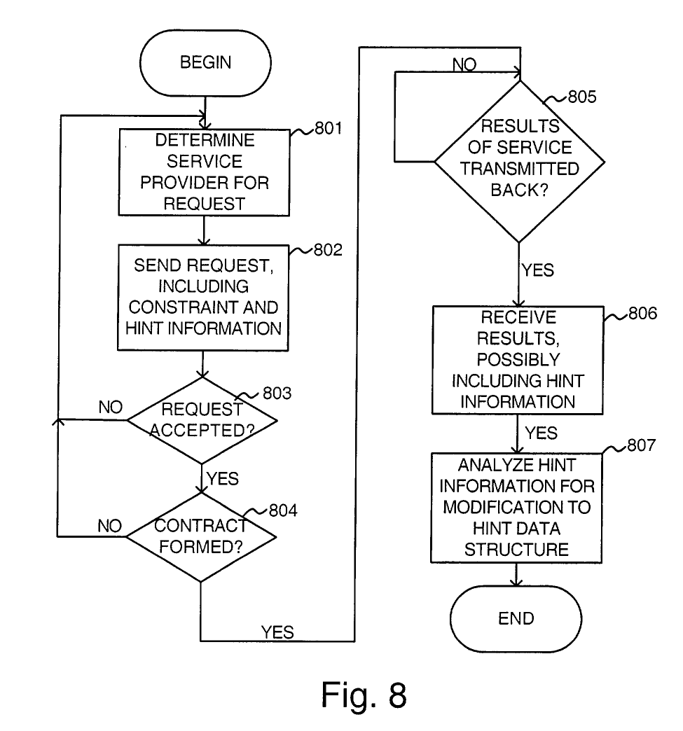

FIG. 8 is a flow chart illustrating methods for performing dynamic service substitution consistent with an aspect of the invention from the standpoint of a service provider 401 requesting a service from another service provider. Requesting service provider 401 may alternatively be a client or other non-service providing network entity.

To begin, the requesting service provider 401 determines the service provider from which to request the service (Act 801). As previously mentioned, this determination can be made based on, for example, constraint data structure 500 and/or hint data structure 600.

Requesting service provider 401 sends a service request to the determined service provider (Act 802). The service request may include constraint data structure 500 and/or hint data structure 600. After the request is accepted and a contract is formed, (Acts 803 and 804), results may be returned for the service (Acts 805 and 806). The results may include information relating to the hint information. Hint generation engine 702 may analyze the hint information and modify hint data structure 600 when appropriate (Act 807). By modifying hint data structure 600, the distributed system may learn from prior experience and, thus, implement adaptive service substitution.

### Conclusion

As described above, components of a distributed application can self-heal based on the mirroring of certain ones of the components. Hint data is used to make the healing process intelligent (adaptive). The intelligent aspect of the components may also be used when initially assembling a workflow.

It will be apparent to one of ordinary skill in the art that aspects of the invention, as described above, may be implemented in many different forms of software, firmware, and hardware in the implementations illustrated in the figures. The actual software code or specialized control hardware used to implement aspects consistent with the present invention is not limiting of the present invention. Thus, the operation and behavior of the aspects were described without reference to the specific software code—it being understood that a person of ordinary skill in the art would be able to design software and control hardware without undue experimentation to implement the aspects based on the description herein.

The foregoing description of preferred embodiments of the present invention provides illustration and description, but is not intended to be exhaustive or to limit the invention to the precise form disclosed. Modifications and variations are possible in light of the above teachings or may be acquired from practice of the invention.

For example, although software “gauges” and “probes” were described in implementing the adaptive mirroring, other elements may be used to monitor a service provider state.

No element, act, or instruction used in the description of the present application should be construed as critical or essential to the invention unless explicitly described as such. Also, as used herein, the article “a” is intended to include one or more items. Where only one item is intended, the term “one” or similar language is used.

The scope of the invention is defined by the claims and their equivalents.

What is claimed:

1. A method for replacing a first service in a distributed application, the method comprising:
monitoring the first service;
determining, based on the monitoring, when the first service stops providing an acceptable level of service; and
substituting a mirror service for the first service when the first service is determined to have stopped providing the acceptable level of service, the mirror service being determined based on directive information that includes hint information and constraint information, the constraint information defining rigid service rules and the hint information providing suggestive information relating to services.

2. The method of claim 1, wherein determining when the first service stops providing an acceptable level of service is based on information provided by software probes associated with the first service.

3. The method of claim 2, wherein the information provided by the software probes is gathered by software gauges.

4. The method of claim 3, wherein the software gauges aggregate and interpret the information provided by the software probes.

5. The method of claim 1, wherein determining when the first service stops providing an acceptable level of service includes:
determining that the first service has failed.

6. The method of claim 1, wherein determining when the first service stops providing an acceptable level of service includes:
determining that the first service has violated a constraint defined by the constraint information.

7. The method of claim 1, wherein a connector component is used to substitute the mirror service for the first service.

8. A distributed application comprising:
means for monitoring a first service of the distributed application;
means for determining, based on an output of the means for monitoring, when the first service stops providing an acceptable level of service; and
means for substituting a second service for the first service when the first service is determined to have stopped providing an acceptable level of service, the second service being determined based on directive information that includes hint information and constraint information, the constraint information defining rigid service rules and the hint information providing suggestive information relating to services.

9. A method for assembling a workflow of distributed service providers, the method comprising:
receiving a request for a first service, the request including constraint information and hint information, the constraint information defining rigid service rules and the hint information providing suggestive information relating to services;
requesting a second service required to complete the first service based on the constraint information and the hint information;
receiving feedback information from the second service; and
modifying the hint information based on the feedback information.

10. The method of claim 9, wherein the workflow is assembled based on a Service and Contract workflow protocol.

11. The method of claim 9, wherein the first service and the second service are provided by service providers on different computer systems.

12. The method of claim 9, wherein the constraint information includes at least one of:
a list of suitable service providers, and
a service specification.

13. The method of claim 9, wherein the hint information includes at least one of:
suggested service destinations, and
historical invocation time information.

14. The method of claim 9, wherein modifying the hint information based on the feedback information is performed using a set of predefined rules.

15. A system comprising:
a first computing device including
a first processor, and
a first memory operatively coupled to the first processor, the first memory including instructions for implementing a first service, the first service including constraint information and hint information, the constraint information defining rigid service rules and the hint information providing suggestive information relating to the first service, the hint information being based on feedback information; and
a second computing device including
a second processor, and
a second memory operatively coupled to the second processor, the second memory including
instructions for implementing a second service,
instructions for receiving a request from the first service to invoke the second service, the request including the constraint information and the hint information, and
instructions for providing the feedback information to the first service based on execution of the first service.

16. The system of claim 15, wherein the second service is selected by the first service based on the hint information.

17. The system of claim 15, wherein the first service further includes:
a hint generation engine that receives the feedback information from the second service and modifies the hint information based on the feedback information.

18. The system of claim 15, wherein the constraint information includes at least one of:
a list of suitable service providers, and
a service specification.

19. The system of claim 15, wherein the hint information includes at least one of:
suggested service destinations, and
historical invocation time information.

20. The system of claim 15, wherein the first and the second services define a distributed application.

21. A computer-readable medium storing instructions for causing at least one processor to perform a method for assembling a workflow of distributed service providers, the computer-readable medium comprising:
instructions for receiving a request from a first service, the request including constraint information and hint information, the constraint information defining rigid service rules and the hint information providing suggestive information relating to services;
instructions for requesting a second service required to complete the first service based on the constraint information and the hint information;
instructions for receiving feedback information from the second service; and
instructions for modifying the hint information based on the feedback information.

22. The computer-readable medium of claim 21, wherein the workflow is assembled based on a Service and Contract workflow protocol.

23. The computer-readable medium of claim 21, wherein the first service and the second service are provided by service providers on different computer systems.

24. The computer-readable medium of claim 21, wherein the constraint information includes at least one of:
a list of suitable service providers, and
a service specification.

25. The computer-readable medium of claim 21, wherein the hint information includes at least one of:
suggested service destinations, and
historical invocation time information.

26. The computer-readable medium of claim 21, wherein modifying the hint information based on the feedback information is performed using a set of predefined rules.
